(19) United States
(12) Patent Application Publication
(10) Pub. No.: US 2009/0285210 A1
(43) Pub. Date: Nov. 19, 2009

(54) NETWORK DEVICE AND METHOD FOR DETECTING RTP PACKETS

(75) Inventors: LU-MENG HSU, Tu-Cheng (TW); Yew-Min Lo, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/212,663

(22) Filed: Sep. 18, 2008

(30) Foreign Application Priority Data
May 16, 2008 (TW) 97118016

(51) Int. Cl. H04L 12/28

(52) U.S. Cl. 370/389

(57) ABSTRACT

A network device includes a real-time transport protocol (RTP) stream prediction table (SPT), a receiving module, a stream determining module, a service module, and a transmitting module. The RTP SPT includes a plurality of packet entries, each of which comprises common parameters. The receiving module receives a packet that comprises individual parameters. The stream determining module determines if the received packet matches with one of the packet entries of the RTP SPT by comparing the individual parameters of the received packet with the common parameters of each of the packet entries of the RTP SPT. The service module provides quality of service (QoS) for the received packet when the received packet matches with one of the packet entries of the RTP SPT. The transmitting module transmits the received packet based on QoS. A method for detecting RTP packets is also provided.

### BACKGROUND

1. Field of the Invention

Embodiments of the present disclosure relates to network communications, and particularly to a network device and a method for detecting real-time transport protocol (RTP) packets.

2. Description of Related Art

The real-time transport protocol (RTP) defines a standardized packet format for delivering audio and video over the Internet. RTP packets do not have standard transport control protocol (TCP) or user datagram protocol (UDP) ports on which they communicate. Additionally, the RTP does not provide mechanisms to ensure timely delivery and also does not guarantee quality of service (QoS), all of which must be provided by some other mechanism.

Accordingly, it would be advantageous to provide a network device and a method that can overcome the aforementioned deficiencies.

### SUMMARY

One embodiment of the present disclosure provides a network device. The network device includes a real-time transport protocol (RTP) stream prediction table (SPT), a receiving module, a stream determining module, a service module, a transmitting module, and a processor. The RTP SPT includes a plurality of packet entries, wherein each of the packet entries comprises common parameters including a common synchronization source (SSRC) identifier. The receiving module is configured for receiving a packet that comprises individual parameters including an individual SSRC identifier. The stream determining module is configured for determining if the received packet matches with one of the packet entries of the RTP SPT by comparing the individual parameters of the received packet with the common parameters of each of the packet entries. The service module is configured for providing quality of service (QoS) for the received packet when the received packet matches with one of the packet entries of the RTP SPT. The transmitting module is configured for transmitting the received packet based on the QoS. The processor executes the RTP SPT, the receiving module, the stream determining module, the service module, and the transmitting module.

Another embodiment of the present disclosure provides a method for detecting real-time transport protocol (RTP) packets. The method includes the following blocks: providing an RTP stream prediction table (SPT) comprising a plurality of packet entries, each packet entry comprising common parameters including a common synchronization source (SSRC) identifier; receiving a packet that comprises individual parameters including an individual SSRC identifier; determining if the received packet matches with one of the packet entries of the RTP SPT by comparing the individual parameters of the received packet with the common parameters of each of the packet entries; providing quality of service (QoS) for the received packet when the received packet matches with one of the packet entries of the RTP SPT; and transmitting the received packet based on the QoS.

Other advantages and novel features of the present disclosure will become more apparent from the following detailed description of preferred embodiments when taken in conjunction with the accompanying drawings, in which:

### BRIEF DESCRIPTION OF THE DRAWINGS

FIG. 1 is a schematic diagram of functional modules of a network device in accordance with one embodiment of the present disclosure;

FIG. 2 is a flowchart of one embodiment of a method for detecting real-time transport protocol (RTP) packets in accordance with the present disclosure; and

FIG. 3 is a flowchart of one embodiment of a method for refreshing an RTP stream prediction table (SPT) in accordance with the present disclosure.

### DETAILED DESCRIPTION OF CERTAIN INVENTIVE EMBODIMENTS

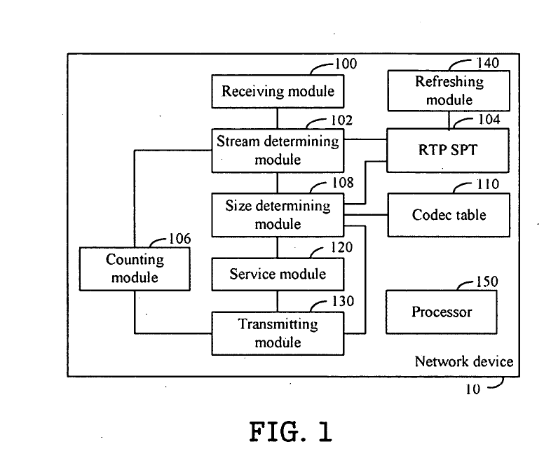

FIG. 1 is a schematic diagram of functional modules of a network device 10 in accordance with one embodiment of the present disclosure. In one embodiment, the network device 10 may be a voice over Internet protocol (VoIP) device or another device that utilizes real-time transport protocol (RTP). The network device 10 includes a receiving module 100, a stream determining module 102, an RTP stream prediction table (SPT) 104, a service module 120, and a transmitting module 130. The network device 10 further includes a processor 150 for executing the receiving module 100, the stream determining module 102, the RTP SPT 104, the service module 120, and the transmitting module 130.

The RTP SPT 104 includes a plurality of packet entries, each packet entry including common parameters as will be further explained below. In one embodiment, the common parameters comprise at least a common synchronization source (SSRC) identifier.

The receiving module 100 is configured for receiving a packet from a network. In one embodiment, the received packet includes individual parameters, wherein the individual parameters comprise at least an individual SSRC identifier.

The stream determining module 102 is configured for determining if the received packet matches with one of the packet entries of the RTP SPT 104 by comparing the common parameters of each of the packet entries with the individual parameters of the received packet. In one embodiment, if the individual parameters of the received packet match with the common parameters of one of the packet entries of the RTP SPT 104, the stream determining module 102 determines that the received packet matches with the packet entry. If the individual parameters of the received packet do not match with the common parameters of any packet entry of the RTP SPT 104, the stream determining module 102 determines that the received packet does not match with the packet entry of RTP SPT 104.

In one embodiment, the individual parameters of the received packet may further include an individual source IP address, an individual destination IP address, an individual source port, and an individual destination port of a destination address or a destination device. The common parameters of each of the packet entries of the RTP SPT 104 may further include a common source IP address, a common destination IP address, a common source port, and a common destination port of a destination address or a destination device. In one embodiment, the stream determining module 102 determines if the received packet matches with the packet entry of the RTP SPT 104. The determining is done by a series of comparisons. In one embodiment, the stream determining module 102 compares the individual source IP address of the received packet with the common source IP address of each packet entry of the RTP SPT 104, and compares the individual destination IP address of the received packet with the common individual destination IP address of the packet entry of the RTP SPT 104. The stream determining module 102 further compares the individual source port of the received packet with the common source port of the packet entry of the RTP SPT 104, and compares the individual destination port of the received packet with the common destination port of the packet entry of the RTP SPT 104. Furthermore, the stream determining module 102 further compares the individual SSRC identifier of the received packet with the common SSRC identifier of the packet entry of the RTP SPT 104.

The stream determining module 102 is further configured for determining if the received packet matches with the packet entry of the RTP SPT 104 by a series of matching. In one embodiment, the individual source IP address of the received packet matches with the common source IP address of the packet entry of the RTP SPT 104, and the individual destination IP address of the received packet matches with the common destination IP address of the packet entry of the RTP SPT 104. Additionally, the individual source port of the received packet matches with the common source port of the packet entry of the RTP SPT 104, and the individual destination port of the received packet matches with the common destination port of the packet entry of the RTP SPT 104. Furthermore, the individual SSRC identifier of the received packet matches with the common SSRC identifier of the packet entry of the RTP SPT 104.

If one of the individual parameters of the received packet does not match with the corresponding common parameter of any one of the packet entries of RTP SPT 104, the stream determining module 102 determines that the received packet does not match with any packet entry of the RTP SPT 104.

The service module 120 is configured for providing quality of service (QoS) for the received packet when the received packet matches with one of the packet entries of the RTP SPT 104.

The transmitting module 130 is configured for transmitting the received packet based on the QoS provided by the service module 120.

Preferably, the network device 10 may further comprise a size determining module 108, a codec table 110, a counting module 106, and a refreshing module 140. A codec is a method or standard for encoding data stream or signals into RTP packets with a fixed packet size. In one embodiment, the network device 10 checks if a size of the received packet matches with the fixed packet size to determine if the received packet is an RTP packet. If the received packet matches the fixed packet size, the network device 10 determines that the received packet is an RTP packet. If the received packet does not matches with the fixed packet size, the network device 10 determines that the received packet is not an RTP packet.

The codec table 110 includes a plurality of RTP packet sizes fixed for each codec.

The size determining module 108 is configured for determining if a size of the received packet matches with one RTP packet size of the codec table 110 when the received packet does not match with any packet entry of the RTP SPT 104. Accordingly, the size determining module 108 creates a new packet entry in the RTP SPT 104 when the size of the received packet matches with one RTP packet size of the codec table 110.

Each packet entry of the RTP SPT 104 may further include a counter for recording a number of received packets matched with the packet entry. The counting module 106 is configured for updating the counter of the matched packet entry when the received packet matches with one packet entry of the RTP SPT 104 and for determining if the counter exceeds a predetermined threshold. The service module 120 is further configured for providing QoS for all received packets matched with the packet entry when the counter exceeds the predetermined threshold. It may be understood that the counter of the matched packet entry may be stored on a storage system of the network device 10. The storage system, depending on the embodiment, may be a hard disk drive, a flash drive, or random access memory.

Each packet entry of the RTP SPT 104 may further comprise a last processing time for recording a last processing time of received packets matched with the packet entry. The refreshing module 140 is configured for checking the last processing time of each of the packet entries to determine if one or more of the packet entries time out and deleting the timeout packet entry in the RTP SPT 104.

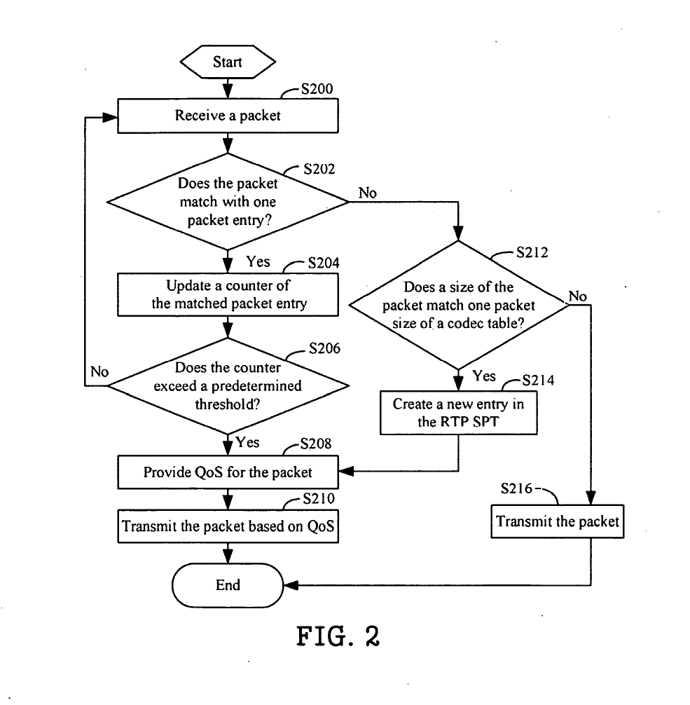

FIG. 2 is a flowchart of a method for detecting RTP packets in accordance with one embodiment. In one embodiment, the method is executed by the functional modules of FIG. 1. Depending on the embodiment, additional blocks may be added, others deleted, and the ordering of the blocks may be changed.

In block S200, the receiving module 100 receives a packet from a network. In one embodiment, the received packet includes individual parameters comprising an individual source IP address, an individual destination IP address, an individual source port, an individual destination port, and an individual SSRC identifier.

In block S202, the stream determining module 102 determines if the received packet matches with one of the packet entries of the RTP SPT 104 by comparing the individual parameters of the received packet with the common parameters of each of the packet entries of the RTP SPT 104. In one embodiment, the stream determining module 102 determines if the received packet matches with the packet entry of the RTP SPT 104. The determining is done by a series of comparisons. In one embodiment, the stream determining module 102 compares the individual source IP address of the received packet with the common source IP address of each packet entry of the RTP SPT 104, and compares the individual destination IP address of the received packet with the common individual destination IP address of the packet entry of the RTP SPT 104. The stream determining module 102 further compares the individual source port of the received packet with the common source port of the packet entry of the RTP SPT 104, and compares the individual destination port of the received packet with the common destination port of the packet entry of the RTP SPT 104. Furthermore, the stream determining module 102 further compares the individual SSRC identifier of the received packet with the common SSRC identifier of the packet entry of the RTP SPT 104.

The stream determining module 102 determines that the received packet matches with the packet entry of the RTP SPT 104 by a series of matching. In one embodiment, the individual source IP address of the received packet matches with the common source IP address of the packet entry of the RTP SPT 104, and the individual destination IP address of the received packet matches with the common destination IP address of the packet entry of the RTP SPT 104. Additionally, the individual source port of the received packet matches with the common source port of the packet entry of the RTP SPT 104, and the individual destination port of the received packet matches with the common destination port of the packet entry of the RTP SPT 104. Furthermore, the individual SSRC identifier of the received packet matches with the common SSRC identifier of the packet entry of the RTP SPT 104.

If one of the individual parameters does not match with the corresponding common parameter of any one of the packet entries of RTP SPT 104, the stream determining module 102 determines that the received packet does not match with any packet entry of the RTP SPT 104.

If the received packet matches with one of the packet entries of the RTP SPT 104, in block S204, the counting module 106 updates the counter of the matched packet entry, which may be incrementing the counter of the matched packet entry by 1.

In block S206, the counting module 106 determines if the counter of the matched packet entry exceeds a predetermined threshold.

If the counter of the matched packet entry does not exceed the predetermined threshold, the flow moves back to block S200 where the receiving module 100 receives another packet from the network.

If the counter of the matched packet entry exceeds the predetermined threshold, in block S208, the service module 120 provides QoS for all received packets matched with the packet entry.

In block S210, the transmitting module 130 transmits all received packets matched with the packet entry based on the QoS.

If the received packet does not match with any packet entry of the RTP SPT 104, in block S212, the size determining module 108 determines if a size of the received packet matches with one RTP packet size of the codec table 110.

If the size of the received packet matches with one RTP packet size of the codec table 110, in block S214, the size determining module 108 creates a new packet entry in the RTP SPT 104.

In block S208, the service module 120 provides QoS for the received packet.

In block S210, the transmitting module 130 transmits the received packet based on the QoS.

If the size of the received packet does not match with any RTP packet size of the codec table 110, in block S216, the transmitting module 130 transmits the received packet without the QoS.

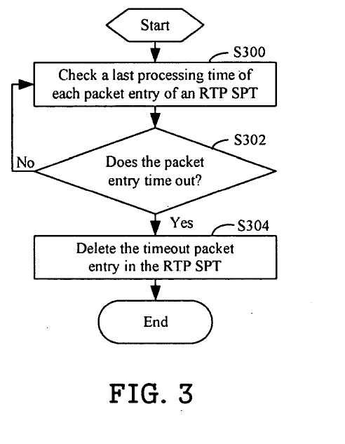

FIG. 3 is a flowchart of one embodiment of a method for refreshing the RTP SPT 104 in accordance with the present disclosure. Depending on the embodiment, additional blocks may be added, others deleted, and the ordering of the blocks may be changed.

In block S300, the refreshing module 140 checks the last processing time of each packet entry.

In block S302, the refreshing module 140 determines if the packet entry times out. In one exemplary embodiment, the refreshing module 140 checks if the last processing time of the packet entry exceeds a standard processing time to determine if the packet entry times out. The standard processing time is predefined according to requirements and may be 1 second, for example. If the last processing time of the packet entry exceeds the standard processing time, the packet entry times out. If the last processing time of the packet entry does not exceed the standard processing time, the packet entry does not time out.

If the packet entry does not time out, returning to S300, the refreshing module 140 goes on to check the last processing time of each packet entry of the RTP SPT 104.

If the packet entry times out, the refreshing module 140 deletes the timeout packet entry in the RTP SPT 104.

Thus, the network device 10 and the method for detecting RTP packets can conveniently and quickly detect RTP packets and provide QoS for RTP packets.

While various embodiments and methods of the present disclosure have been described above, it should be understood that they have been presented by way of example only and not by way of limitation. Thus, the breadth and scope of the present disclosure should not be limited by the above-described exemplary embodiments, but should be defined only in accordance with the following claims and their equivalents.

What is claimed is:

1. A network device for providing quality of service (QoS) for real-time transport protocol (RTP) packets transmitted through the network device, the network device comprising:
an RTP stream prediction table (SPT) comprising a plurality of packet entries, each of the packet entries comprising common parameters including a common synchronization source (SSRC) identifier;
a receiving module configured for receiving a packet that comprises individual parameters including an individual SSRC identifier;
a stream determining module configured for determining if the received packet matches with one of the packet entries of the RTP SPT by comparing the individual parameters of the received packet with the common parameters of each of the packet entries;
a service module configured for providing QoS for the received packet when the received packet matches with one of the packet entries of the RTP SPT;
a transmitting module configured for transmitting the received packet based on QoS; and
a processor executing the RTP STP, the receiving module, the stream determining module, the service module, and the transmitting module.

2. The network device of claim 1, wherein the common parameters of each packet entry of the RTP SPT further comprise a common source Internet Protocol (IP) address, a common destination IP address, a common source port, and a common destination port, wherein the individual parameters of the received packet further comprise an individual source IP address, an individual destination IP address, an individual source port, and an individual destination port.

3. The network device of claim 2, wherein the stream determining module is further configured for comparing the individual source IP address of the received packet with the common source IP address of each packet entry of the RTP SPT, comparing the individual destination IP address of the received packet with the common destination IP address of the packet entry of the RTP SPT, comparing the individual source port of the received packet with the common source port of the packet entry of the RTP SPT, comparing the individual destination port of the received packet with the common destination port of the packet entry of the RTP SPT, and comparing the individual SSRC identifier of the received packet with the common SSRC identifier of the packet entry of the RTP SPT, so as to determine if the received packet matches with the packet entry of the RTP SPT.

4. The network device of claim 2, wherein each packet entry of the RTP SPT further comprises a counter for recording a number of received packets matched with the packet entry, wherein the counter may be stored in a storage system of the network device.

5. The network device of claim 4, further comprising a counting module configured for updating the counter of the matched packet entry when the received packet matches with one packet entry of the RTP SPT and for determining if the counter exceeds a predetermined threshold.

6. The network device of claim 5, wherein the service module is further configured for providing QoS for all received packets matched with the packet entry when the counter exceeds the predetermined threshold.

7. The network device of claim 4, wherein each packet entry of the RTP SPT further comprises a last processing time for recording a last processing time of received packets matched with the packet entry.

8. The network device of claim 7, further comprising a refreshing module for checking the last processing time of each of the packet entries to determine if one or more of the packet entries time out and deleting the timeout packet entry in the RTP SPT.

9. The network device of claim 1, further comprising:
a codec table comprising a plurality of RTP packet sizes; and
a size determining module configured for determining if a size of the received packet matches with one RTP packet size of the codec table when the received packet does not match with any packet entry of the RTP SPT; and configured for creating a new packet entry in the RTP SPT when the size of the received packet matches with one RTP packet size of the codec table.

10. A method for detecting real-time transport protocol (RTP) packets, comprising:
providing an RTP stream prediction table (SPT) comprising a plurality of packet entries, each of the packet entries comprising common parameters including a synchronization source (SSRC) identifier;
receiving a packet that comprises individual parameters including an individual SSRC identifier;
determining if the received packet matches with one of the packet entries of the RTP SPT by comparing the individual parameters of the received packet with the common parameters of each of the packet entries;
providing quality of service (QoS) for the received packet if the received packet matches with one of the packet entries of the RTP SPT; and
transmitting the received packet based on QoS.

11. The method of claim 10, wherein the common parameters of each packet entry of the RTP SPT further comprise a common source Internet Protocol (IP) address, a common destination IP address, a common source port, and a common destination port; the individual parameters of the received packet further comprise an individual source IP address, an individual destination IP address, an individual source port, and an individual destination port.

12. The method of claim 11, wherein the block of determining if the received packet matches with one of the packet entries of the RTP SPT comprises:
comparing the individual source IP address of the received packet with the common individual source IP address of each packet entry of the RTP SPT, comparing the individual destination IP address of the received packet with the common destination IP address of the packet entry of the RTP SPT, comparing the individual source port of the received packet with the common source port of the packet entry of the RTP SPT, comparing the individual destination port of the received packet with the common destination port of the packet entry of the RTP SPT, and comparing the individual SSRC identifier of the received packet with the common SSRC identifier of the packet entry of the RTP SPT, so as to determine if the received packet matches with the packet entry of the RTP SPT.

13. The method of claim 11, wherein each packet entry of the RTP SPT further comprises a counter for recording a number of received packets matched with the packet entry.

14. The method of claim 13, further comprising:
updating the counter of the matched packet entry if the received packet matches with one of the packet entries of the RTP SPT;
determining if the counter exceeds a predetermined threshold; and
providing QoS for all received packets matched with the packet entry if the counter exceeds the predetermined threshold.

15. The method of claim 13, wherein each packet entry of the RTP SPT further comprises a last processing time for recording a last processing time of received packets matched with the packet entry.

16. The method of claim 15, further comprising:
checking the last processing time of each packet entry;
determining if the packet entry times out; and
deleting the timeout packet entry in the RTP SPT if the packet entry times out.

17. The method of claim 10, further comprising:
providing a codec table comprising a plurality of RTP packet sizes;
determining if a size of the received packet matches with one RTP packet size of the codec table if the received packet does not match with any packet entry of the RTP SPT; and
creating a new packet entry in the RTP SPT if the size of the received packet matches one RTP packet size of the codec table.
